(19) United States
(12) Patent Application Publication
(10) Pub. No.: US 2021/0279210 A1
(43) Pub. Date: Sep. 9, 2021

(54) Devices, System and Methods for Deduplication

(71) Applicant: Huawei Technologies Co., Ltd., Shenzhen (CN)

(72) Inventors: Yaron Mor, Hod Hasharon (IL); Aviv Kuvent, Hod Hasharon (IL); Asaf Yeger, Hod Hasharon (IL)

(21) Appl. No.: 17/326,890

(22) Filed: May 21, 2021

Related U.S. Application Data
(63) Continuation of application No. PCT/EP2019/069753, filed on Jul. 23, 2019.

(51) Int. Cl. G06F 16/174; G06F 16/14; G06F 16/185; H04L 29/08

(52) U.S. Cl. CPC G06F 16/1752; H04L 67/1002; G06F 16/185; G06F 16/152

(57) ABSTRACT

A method for deduplicating at a global server for multiple storage servers includes receiving, from a storage server, a request to store a data chunk, determining whether the data chunk is highly-duplicated among the storage servers, accepting the request when the data chunk is highly-duplicated, and rejecting the request when the data chunk is not highly-duplicated.

### CROSS-REFERENCE TO RELATED APPLICATIONS

This application is a continuation of International Patent Application No. PCT/EP2019/069753 filed on Jul. 23, 2019, which is hereby incorporated by reference in its entirety.

### TECHNICAL FIELD

The present disclosure relates to a data storage deduplication method, in particular, to a deduplication method of multiple deduplication servers. The disclosure thus introduces an advanced deduplication method allowing easy deployment of storage servers, in which a global server stores highly-duplicate data among multiple storage servers. The global server can be a centralized server, or a distributed server.

### BACKGROUND

Data deduplication (or data optimization) refers to reducing the physical amount of bytes of data that need to be stored on disk or transmitted across a network, without compromising the fidelity or integrity of the original data, i.e., the reduction in bytes is lossless and the original data can be completely recovered. By reducing the storage resources to store and/or transmit data, data deduplication thus leads to savings in hardware costs (for storage and network transmission) and data-managements costs (e.g., backup). As the amount of digitally stored data grows, these cost savings become significant.

Data deduplication typically uses a combination of techniques to eliminate redundancy within and between persistently stored files. One technique operates to identify identical regions of data in one or multiple files, and physically storing only one unique region (referred to as chunk), while maintaining a pointer to that chunk in association with the file. Another technique is to mix data deduplication with compression, e.g., by storing compressed chunks.

Many organizations use dedicated servers to store data (storage servers). Data stored by different servers is often duplicated, resulting in space loss. A solution for this problem is deduplication, which is storing only unique data up to a certain granularity, by using hashes to identify duplicates. However, deduplication is performed in the granularity of a specific single storage server.

To prevent duplication of data across servers, a distributed data deduplication is often used. However, one problem of the distributed deduplication is a possible high latency between deduplication servers, which results in a possible read performance degradation. Another problem is a strong dependency between the deduplication nodes. In one example, when one deduplication node is taken out from the cluster, data stored in this node needs to be distributed across other nodes in the cluster. In another example, when adding a new deduplication node, data currently in the cluster may need to be re-distributed between nodes of the cluster, in order to balance the load.

### SUMMARY

In view of the above-mentioned disadvantages, embodiments of the present disclosure aim to provide an advanced deduplication method, in particular, with an additional deduplication tier. An objective is to avoid a high latency of the conventional distributed deduplication. One aim is to provide a simple and flexible deployment of multiple independent storage servers.

The objective is achieved by the embodiments provided in the enclosed independent claims. Advantageous implementations of the embodiments of the present disclosure are further defined in the dependent claims.

A first aspect of the disclosure provides a global server for deduplicating multiple storage servers, wherein the global server is configured to receive, from a storage server, a request to store a data chunk, determine whether the data chunk is highly-duplicated among the storage servers, accept the request when the data chunk is highly-duplicated, and reject the request when the data chunk is not highly-duplicated.

This disclosure presents a concept of deduplication of deduplication (nested deduplication), including an additional deduplication tier (performing deduplication of multiple deduplication servers). A global deduplication server (GDS) is proposed, which will store highly-duplicated data. The term “global server” is an abbreviation of “global deduplication server”, and refers to a server for handling the highly-duplicated data in a storage system comprising multiple deduplication servers. In this context, the term “global” refers to the network topology and can be synonymously used for “master”, “overall” or “central”.

In an implementation form of the first aspect, the global server is configured to determine that the data chunk is highly-duplicated among the storage servers when a hash value of the data chunk is associated at the global server with a water mark equal to or higher than a determined value.

The determination of highly-duplicated data can be performed by the GDS, according to some configurable thresholds.

In an implementation form of the first aspect, wherein the request sent by the storage server comprises the hash value of the data chunk.

The hash value can be used to uniquely identify respective data chunk.

In an implementation form of the first aspect, the global server is configured to create or increase a water mark associated with the hash value, upon receiving the request, and register the storage server, which sent the request, for that hash value.

To help determine whether a data chunk is highly-duplicated, the GDS can increase a ref-count per hash, and can register the storage server that requested to add this hash.

In an implementation form of the first aspect, when the water mark is equal to a first value, the global server is configured to instruct the storage server to send the data chunk to the global server, and store the data chunk.

The GDS may accept the request and instruct the storage server to send the data to the GDS when the ref-count reaches some high-water mark (HWM).

In an implementation form of the first aspect, after the data chunk is stored, the global server is configured to notify the storage server registered for the hash value of the data chunk that the data chunk has been stored.

Only after storing the data, the GDS may notify all storage servers, which previously requested to add this data, that it has been stored.

In an implementation form of the first aspect, the global server is configured to receive, from the storage server, a request to remove a data chunk, decrease a value of a water mark associated with the hash value of the data chunk, and unregister the storage server for that hash value.

The GDS may decrease the ref-count for the relevant hash and unregister the storage server for this hash when the storage server sends a remove request to the GDS to delete a data.

In an implementation form of the first aspect, when a water mark associated with a hash value of a data chunk is below or equal to a second value, the global server is configured to instruct each storage server registered for the hash value of that data chunk, to copy the data chunk from the global server, and remove the data chunk from the global server, after all storage servers registered for the hash value store the data locally.

When the ref-count for a hash is decreased below or equal to some low-water mark (LWM), the GDS may instruct all storage servers which still require this data to copy it from the GDS, before the GDS removes it from its storage.

In an implementation form of the first aspect, wherein the first value is higher than the second value.

To avoid continually deleting and re-writing the same data, the LWM should be less than the HWM.

In an implementation form of the first aspect, the global server is configured to adjust the first and/or second values dynamically, particularly based on free storage space left in the global server.

When the GDS free storage space decreases below a certain threshold, it may dynamically change its HWM and/or LWM.

In the implementation, the GDS can be implemented as a centralized device (e.g., a server), or deployed in one storage server of the multiple storage servers, or implemented in a distributed manner.

A second aspect of the present disclosure provides a storage server for deduplicating at a global server, wherein the storage server is configured to send, to the global server, a request to store a data chunk, and receive, from the global server, an information indicating that the global server accepts the request or rejects the request.

In this topology, multiple storage servers may be connected to the GDS, but the storage servers do not need to be connected to each other, which is opposed to a distributed deduplication topology.

In an implementation form of the second aspect, the request sent to the global server comprises a hash value of the data chunk.

This disclosure does not limit the types of hashing and chunking techniques used in the storage servers, as long as it is identical across all servers.

In an implementation form of the second aspect, the storage server is configured to receive, from a user, a request to write the data chunk, store the hash value of the data chunk, and create or increase a local counter associated with the hash value.

In order to not send duplicate add or remove requests for the same data to the GDS, the storage server is responsible to identify duplication requests for data from the end-user. This might be achieved by setting a local ref-count for hashes of data.

In an implementation form of the second aspect, the storage server is configured to determine, whether to send to the global server, the request to store the data chunk, when the local counter is equal to or greater than 1.

The storage server is free to decide whether to send, and/or when to send the request to store a data to the GDS.

In an implementation form of the second aspect, when the information received from the global server indicates that the global server accepts the request, the storage server is configured to receive, from the global server, an instruction to send the data chunk to the global server, and send the data chunk to the global server.

In an implementation form of the second aspect, when the information received from the global server indicates that the global server rejects the request, the storage server is configured to store the data chunk locally.

In an implementation form of the second aspect, the storage server is configured to receive, from the global server, a notification that the data chunk has been stored in the global server, remove the locally stored data chunk, and request the data chunk from the global server, when a user requests to read the data chunk.

When the data is offloaded to the GDS, the storage server may decide to delete the locally stored data, and rely on the GDS.

In an implementation form of the second aspect, the storage server is configured to receive, from the global server, a notification that the data chunk has been stored in the global server, and additionally store the data chunk locally.

In addition to storing the data in GDS, a storage server can also decide to cache some data locally, in order to improve read performance.

In an implementation form of the second aspect, the storage server is configured to receive, from the user, a request to delete a data chunk, and decrease a local counter associated with the hash value of the data chunk.

When a data is not required by a user anymore, the corresponding local counter will be decreased accordingly.

In an implementation form of the second aspect, when the local counter associated with the hash value of the data chunk is equal to 0, the storage server is configured to delete the data chunk when it is locally stored, or send, to the global server, a request to remove that data chunk.

When the user requests to delete data from a storage server, and this is the last reference to this data for this storage server, the storage server may check when the data to delete is stored locally or it is in the GDS. When it is in the GDS, the storage server may send a remove request to the GDS.

In an implementation form of the second aspect, the storage server is configured to receive, from the global server, an instruction to copy a data chunk from the global server, copy the data chunk from the global server, and store the data chunk locally.

A duplicated status of a data chunk might change. When the data chunk is not highly-duplicated anymore, the storage server is instructed to re-take the ownership of the data chunk.

In an implementation form of the second aspect, the storage server is configured to determine to stop communicating with the global server, copy, from the global server, all data chunks previously requested to be stored in the global server, store the data chunks locally, and stop communicating with the global server.

A new storage server can start communicating with the GDS without a need to inform other storage servers. Also, the storage server can stop communicating with GDS, without effecting other storage servers' data consistency.

A third aspect of the present disclosure provides a system for deduplicating multiple storage servers, wherein the system comprises a global server according to the first aspect or one of the implementation forms of the first aspect, and multiple storage servers according to the second aspect or one of the implementation forms of the second aspect.

The system of the third aspect and its implementation forms provide the same advantages and effects as described above for the global server of the first aspect and its respective implementation forms, and the storage server of the second aspect and its respective implementation forms.

A fourth aspect of the present disclosure provides a method performed by a global server, wherein the method comprises receiving, from a storage server, a request to store a data chunk, determining whether the data chunk is highly-duplicated among the storage servers, when the data chunk is highly-duplicated, accepting the request, and when the data chunk is not highly-duplicated, rejecting the request.

The method of the fourth aspect and its implementation forms provide the same advantages and effects as described above for the global server of the first aspect and its respective implementation forms.

A fifth aspect of the present disclosure provides a method performed by a storage server, wherein the method comprises sending, to the global server, a request to store a data chunk, and receiving, from the global server, an information indicating that the global server accepts the request or rejects the request.

The method of the fifth aspect and its implementation forms provide the same advantages and effects as described above for the storage server of the second aspect and its respective implementation forms.

The disclosure also relates to a computer program, characterized in program code, which, when run by at least one processor causes said at least one processor to execute any method according to the fourth aspect of the present disclosure and its implementation forms, or the fifth aspect of the present disclosure and its implementation forms. Further, the disclosure also relates to a computer program product comprising a computer readable medium and said mentioned computer program, wherein said computer program is included in the computer readable medium, and comprises of one or more from the group: read-only memory (ROM), programmable ROM (PROM), erasable PROM (EPROM), Flash memory, electrically EPROM (EEPROM) and hard disk drive.

It has to be noted that all devices, elements, units and means described in the present disclosure could be implemented in the software or hardware elements or any kind of combination thereof. All steps which are performed by the various entities described in the present disclosure as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms of the present disclosure will be explained in the following description of specific embodiments in relation to the enclosed drawings. The drawing includes the following brief descriptions.

FIG. 1 shows a global server according to an embodiment of the disclosure.

FIG. 2 shows a topology according to an embodiment of the disclosure.

FIG. 3 shows another topology according to an embodiment of the disclosure.

FIG. 4 shows a communication between a global server and a storage server according to embodiments of the present disclosure.

FIG. 5 shows a communication between a global server and a storage server according to embodiments of the present disclosure.

FIG. 6 shows a communication between a global server and a storage server according to embodiments of the present disclosure.

FIG. 7 shows a communication between a global server and a storage server according to embodiments of the present disclosure.

FIG. 8 shows a communication between a global server and storage servers according to embodiments of the present disclosure.

FIG. 9 shows a communication between a global server and a storage server according to embodiments of the present disclosure.

FIG. 10 shows a communication between a global server and storage servers according to embodiments of the present disclosure.

FIG. 11 shows a communication between a global server and a storage server according to embodiments of the present disclosure.

FIG. 12 shows a communication between a global server and a storage server according to embodiments of the present disclosure.

FIG. 13 shows a global server according to an embodiment of the disclosure.

FIG. 14 shows a flowchart of a method according to an embodiment of the disclosure.

FIG. 15 shows a flowchart of another method according to an embodiment of the disclosure.

### DETAILED DESCRIPTION OF EMBODIMENTS

Illustrative embodiments of method, apparatus, and program product for data storage deduplication are described with reference to the figures. Although this description provides a detailed example of possible implementations, it should be noted that the details are intended to be exemplary and in no way limit the scope of the disclosure.

Moreover, an embodiment/example may refer to other embodiments/examples. For example, any description including but not limited to terminology, element, process, explanation and/or technical advantage mentioned in one embodiment/example is applicative to the other embodiments/examples.

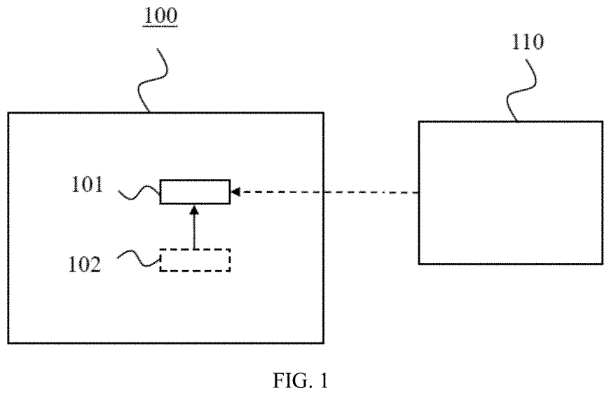

FIG. 1 shows a global server (or a global deduplication server (GDS)) 100 according to an embodiment of the disclosure. The global server 100 may comprise processing circuitry (not shown) configured to perform, conduct or initiate the various operations of the global server 100 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the global server 100 to perform, conduct or initiate the operations or methods described herein. In one implementation, the global server 100 can be implemented as a separated device (e.g. a server), or implemented as a module deployed in one storage server 110. In another implementation, the global server 100 or the storage server 110 can be implemented as a chipset which comprises one or more processors, and storage modules. The embodiments of the disclosure should not be interpreted to restrict the scope of the protection.

The global server 100 is adapted for deduplicating multiple storage servers 110 (one of which is illustrated). The global server 100 is configured to receive, from a storage server 110, a request 101 to store a data chunk 102.

The global server 100 is further configured to determine whether the data chunk 102 is highly-duplicated among the storage servers 110. Accordingly, when the data chunk 102 is highly-duplicated, the global server 100 is configured to accept the request 101. Otherwise, when the data chunk 102 is not highly-duplicated, the global server 100 is configured to reject the request 101.

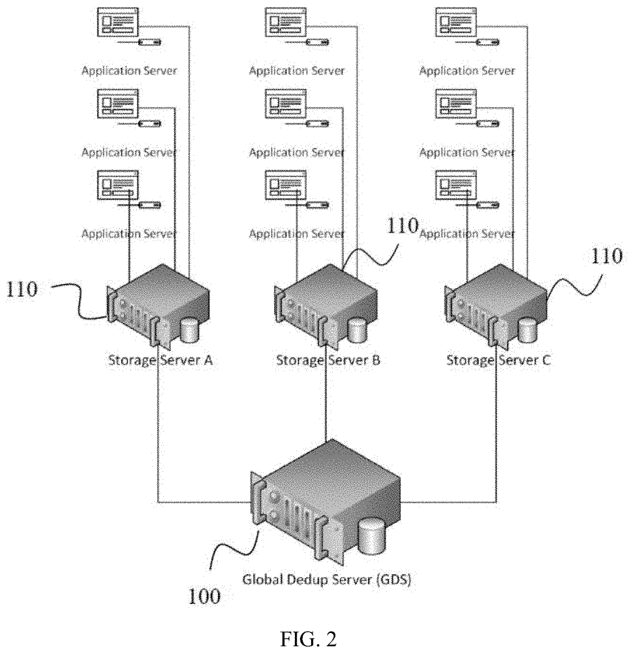

This embodiment of the disclosure presents a concept of deduplication of deduplication (nested deduplication), with an additional deduplication tier. That is, a deduplication of multiple deduplication servers (storage servers) is performed. FIG. 2 shows a topology of a GDS and storage servers A, B and C, according to an embodiment of the disclosure. Notably, opposed to a distributed deduplication structure, the storage servers according to an embodiment of the disclosure are independent of each other. A number of application servers have access to the respective storage server. A user could write/read data to the storage server through the application server.

In particular, the GDS shown in FIG. 2 is the global server 100 according to an embodiment of the disclosure, as shown in FIG. 1. Each of the storage servers A, B and C shown in FIG. 2 is the storage server 100 according to an embodiment of the disclosure, as shown in FIG. 1. The GDS aims to store the highly-duplicated data of the storage servers. In particular, the determination of a highly-duplicated data is done by the GDS, according to some configurable thresholds. The storage servers communicate with the GDS and send requests to store data, which the GDS may accept or reject according to the configured thresholds.

The global server 100 according to an embodiment of the disclosure is configured to determine that the data chunk 102 is highly-duplicated among the storage servers 110, when a hash value of the data chunk 102 is associated at the global server 100 with a water mark equal to or higher than a determined value.

A hash value of a data chunk can be obtained by performing a hash function or hash algorithm on the data chunk. The hash value can be used to uniquely identify respective data chunk. It should be understood that, different types of hash algorithms or functions may be applied to obtain the hash value in this disclosure. This is not specific limited in embodiments of the disclosure.

Optionally, the request 101 sent by the storage server 110 may comprise the hash value of the data chunk 102.

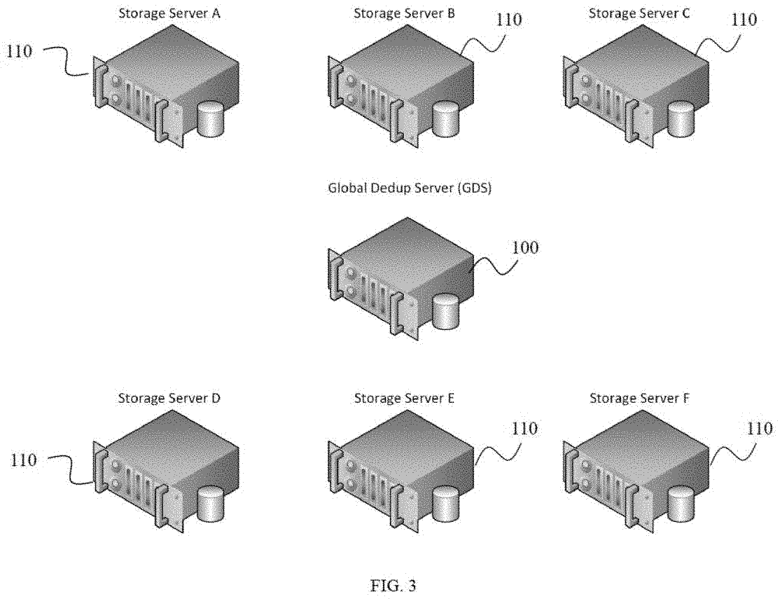

FIG. 3 shows another topology of a GDS and storage servers A—F, according to an embodiment of the disclosure. It should be noted that, the GDS shown in FIG. 3 may be the same global server 100 according to an embodiment of the disclosure, as shown in FIG. 1. Each of the storage servers A—F shown in FIG. 3 may be the same storage server 100 according to an embodiment of the disclosure, as shown in FIG. 1.

Optionally, the global server 100 according to an embodiment of the disclosure is configured to create or increase a water mark associated with the hash value, upon receiving the request 101. Accordingly, the global server 100 according to an embodiment of the disclosure is further configured to register the storage server 110, which sent the request 101, for that hash value. The water mark associated with the hash value may be a reference counter.

It should be noted that, the creating or increasing of the water mark and also the registration of the storage server 110, are triggered only by the receiving of the request 101. Regardless of whether the request 101 to store a data is accepted or rejected by the global server 100, these steps will be performed. That means, even upon rejection of the request 101, the global server 100 still increases the reference count and register the storage server 110.

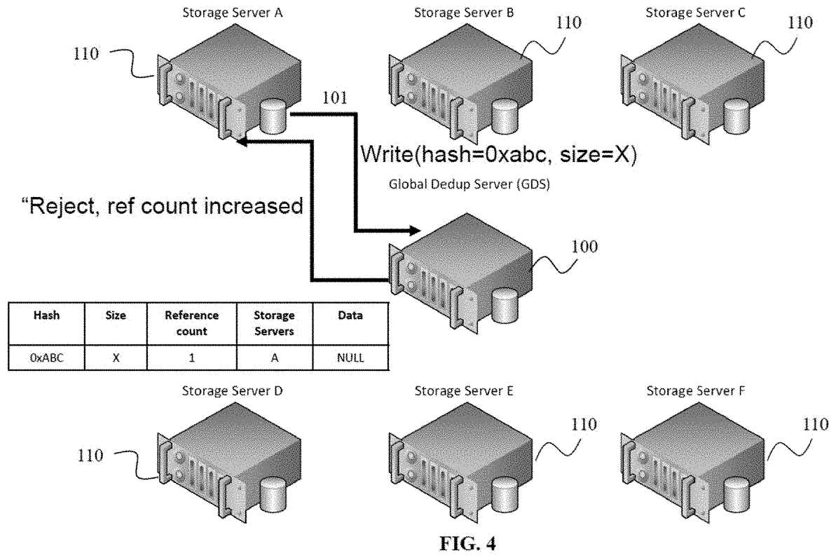

FIG. 4-12 show the same topology of the servers as shown in FIG. 3, according to an embodiment of the disclosure.

In particular, as shown in FIG. 4, storage server A sends a request to write a data, where a hash value of this data is “0×abc”. For instance, this is the first time that the GDS receives the storing data request comprising hash value “0×abc”. According to an embodiment of the disclosure, the GDS create a water mark associate with this hash value, and register storage server A for hash value “0×abc”, as shown in FIG. 4. Since the GDS receives one request to store the data with hash value “0 xabc”, the reference counter associate with hash value “0×abc” is set to be 1. In this embodiment, the water mark is still below a determined value, thus this data is determined to be not highly-duplicated. Therefore, the GDS rejects the request to store the data according to an embodiment of the disclosure.

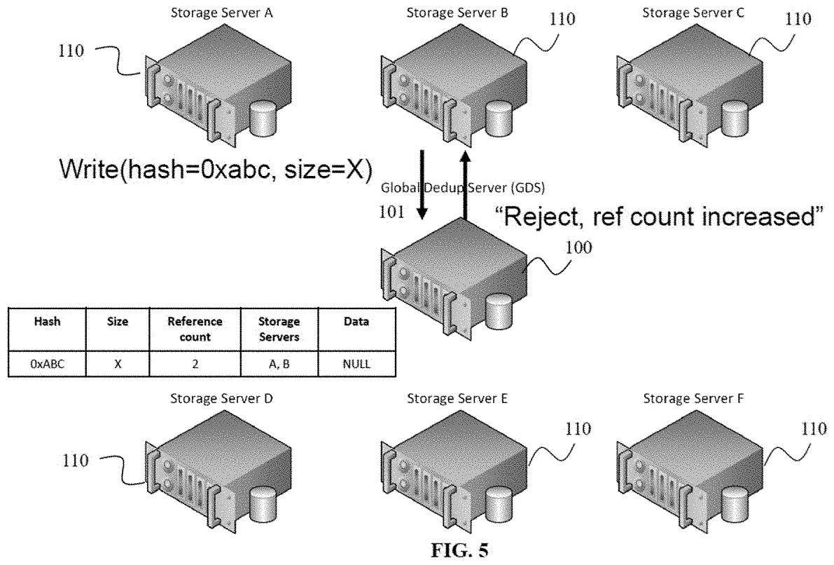

According to an embodiment of the disclosure, storage server B may also send a request to write a data to the GDS as shown in FIG. 5. In particular, storage server B wants to store the same data as storage server A, as shown in FIG. 4, i.e. the data with hash value “0×abc”. Then according to an embodiment of the disclosure, the GDS increases the water mark associate with this hash value, and register storage server B for hash value “0×abc”, as shown in FIG. 5. It can be seen that the reference counter associate with hash value “0×abc” is set to be 2. Since the water mark is still below the determined value according to an embodiment of the disclosure, this data is still determined to be not highly-duplicated. Therefore, the GDS again rejects the request to store the data according to an embodiment of the disclosure.

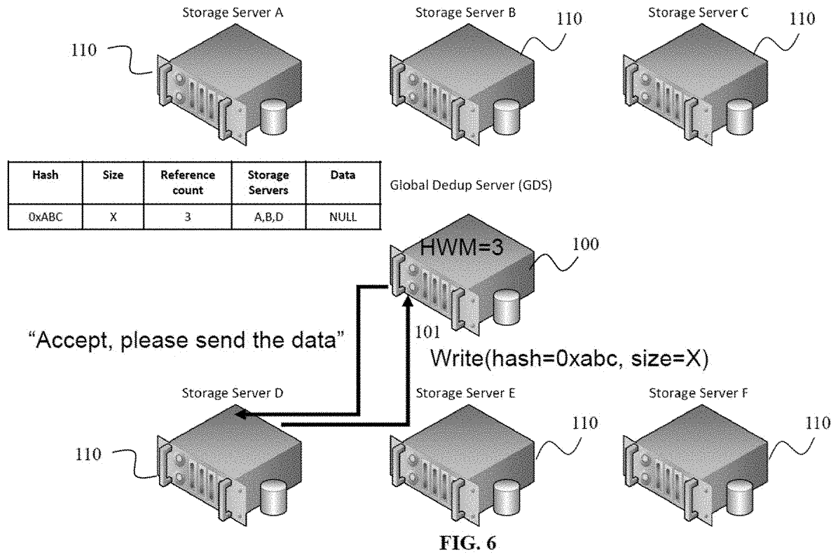

In the following, storage server D may also send a request to write a data to the GDS as shown in FIG. 6. In particular, storage server D wants to store the same data as storage servers A and B, as shown in FIG. 4 and FIG. 5, i.e. the data with hash value “0×abc”. Then according to an embodiment of the disclosure, the GDS increases the water mark associate with this hash value, and register storage server D for hash value “0×abc”, as shown in FIG. 6. It can be seen that the reference counter associate with hash value “0×abc” is set to be 3. For instance, an HWM is predefined to be 3, i.e. the determined value according to an embodiment of the disclosure, used to decide whether the data is highly-duplicated is 3. Since now the water mark/reference counter associated with hash value “0×abc” is equal to the determined value according to an embodiment of the disclosure, this data is determined to be highly-duplicated. Therefore, the GDS accepts the request to store the data according to an embodiment of the disclosure, as shown in FIG. 6.

According to embodiments of the disclosure, the GDS, i.e. the global server 100 as shown in FIG. 1, aims to store the highly-duplicated data. When the water mark is equal to a first value, i.e. an HWM, the global server 100 may be configured to instruct the storage server 110 to send the data chunk 102 to the global server 100. And the global server 100 is further configured to store the data chunk 102.

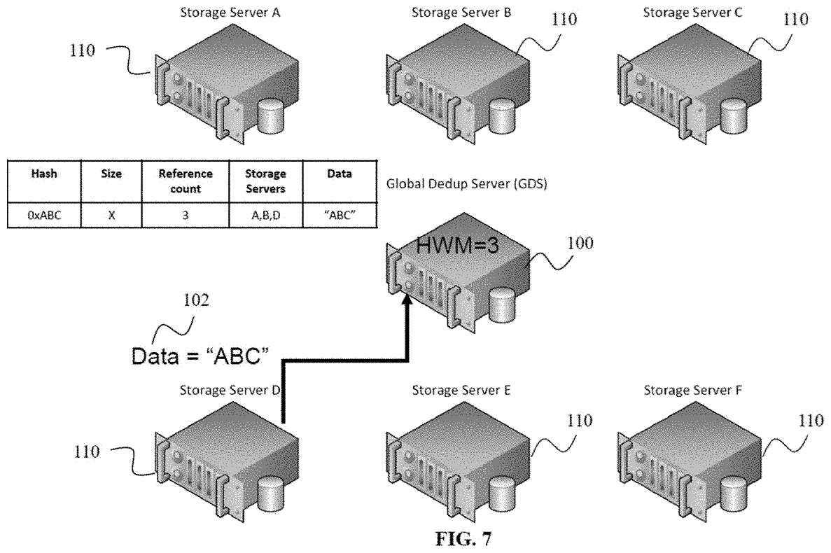

As shown in FIG. 6, upon the acceptance of the request to store the data from storage server D, the GDS further instructs storage server D to send the data. Subsequently, storage server D sends the data, i.e. “ABC”, to the GDS, as shown in FIG. 7. It can be seen that the data “ABC” is stored in the GDS, according to the table shown in FIG. 7. It should be also noted that, since the data has not been stored in the GDS according to embodiments shown in FIG. 4-6, the corresponding parts in the table shown in FIG. 4-6 display “NULL”, which means that no data is stored.

Optionally, after the data chunk 102 is stored, the global server 100, according to an embodiment of the present disclosure, may be configured to notify the storage server 110 registered for the hash value of the data chunk 102 that the data chunk 102 has been stored.

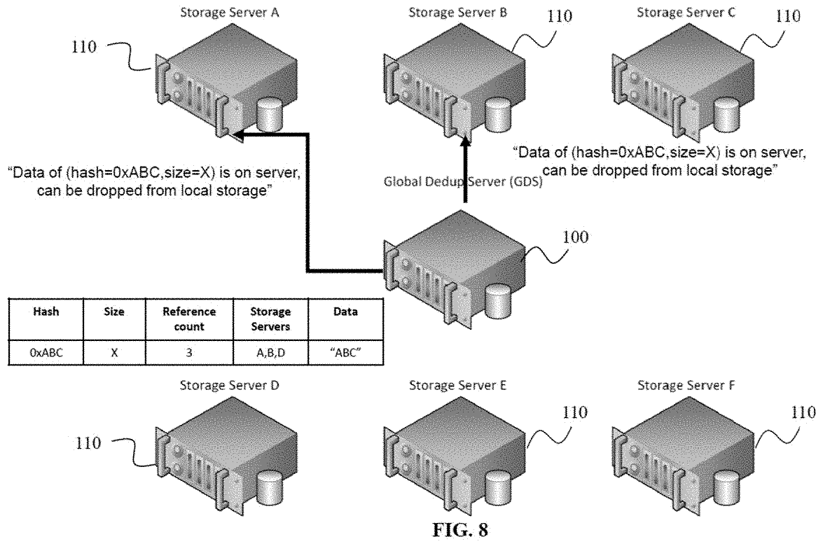

As shown in FIG. 8, the GDS sends a notification according to an embodiment of the disclosure, to storage server A and B respectively, since storage server A and B are registered for the hash value “0×abc”. Storage server A and B can then choose to remove this data from their local storage, and instead rely on the GDS. Optionally, storage server A and B can also decide to keep the data locally, for instance in order to improve read performance.

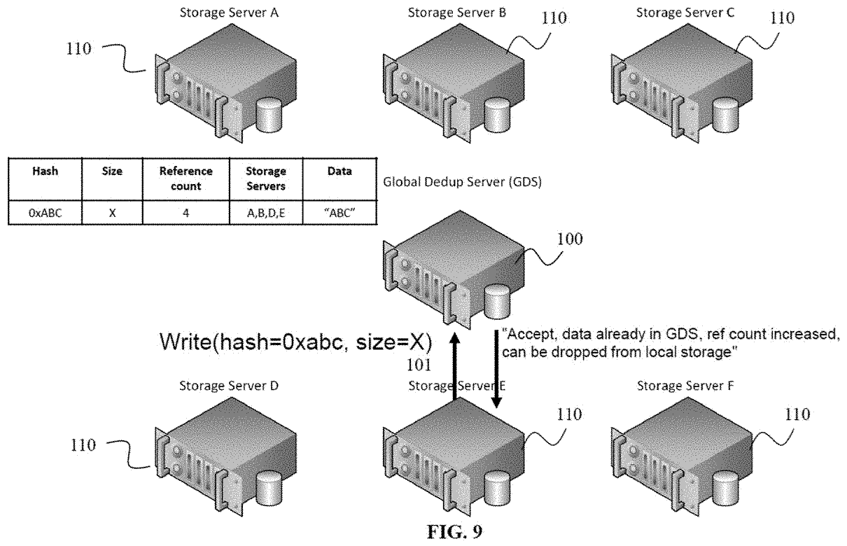

FIG. 9 shows an embodiment of the disclosure after the data is stored in the GDS. In particular, storage server E sends a request to write a data to the GDS as shown in FIG. 9. The data that storage server E needs to store has the hash value “0×abc”. That means this data has been stored in GDS. Then according to an embodiment of the disclosure, the GDS increases the water mark associate with this hash value, and register storage server E for hash value “0×abc”, as shown in FIG. 9. It can be seen that the reference counter associate with hash value “0×abc” is set to be 4. The GDS notifies storage server E that the data is already stored in the GDS. Then accordingly storage server E can decide to remove the data or keep the data locally.

Optionally, the global server 100 according to an embodiment of the disclosure, may be further configured to receive a request 103 to remove a data chunk 102 from the storage server 110. Accordingly, the global server 100 may be configured to decrease a value of a water mark associated with the hash value of the data chunk 102 and unregister the storage server 110 for that hash value.

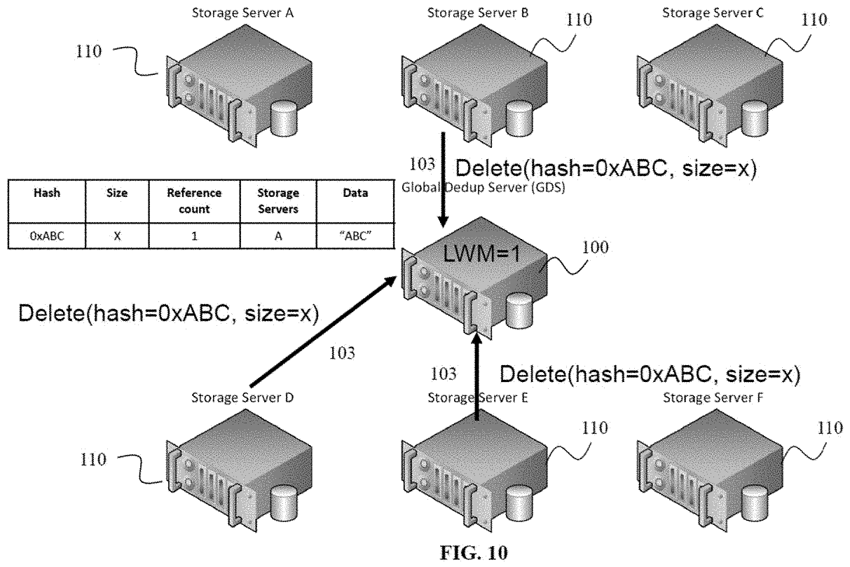

As shown in FIG. 10, storage B, D and E all send a request to delete the data with hash value “0×abc”. According to an embodiment of the disclosure, once the GDS receives a request to delete the data, the GDS decreases the value of the water mark associated with this hash value. In this embodiment, since three requests are received by the GDS, the reference counter associate with hash value “0×abc” is decreased from 4 to 1. It can be seen that, only storage server A is still registered for hash value “0×abc”, as shown in FIG. 10.

It should be understood that, since only one storage server still needs the data with hash value “0×abc”, this data should not be considered as highly-duplicated data anymore. In order to store only the highly-duplicated data in GDS, mechanisms in order to avoid store unnecessary data should be defined.

Accordingly, when a water mark associated with a hash value of a data chunk 102 is below or equal to a second value, i.e. an LWM, the global server 100 is configured to instruct each storage server 110 registered for the hash value of that data chunk 102, to copy the data chunk 102 from the global server 100. After all storage servers 110 registered for the hash value store the data chunk 102 locally, the global server 100 is configured to remove the data chunk 102.

The GDS can choose different methods to distribute the instructions to storage servers to read data, in order to prevent a burst of traffic in a short window of time. For example, the GDS may split the storage servers that need to read the data into N groups (N depending on total number of storage servers that need to read the data). Possibly, the GDS may only instruct group X to read the data after all storage servers in group X−1 read the data.

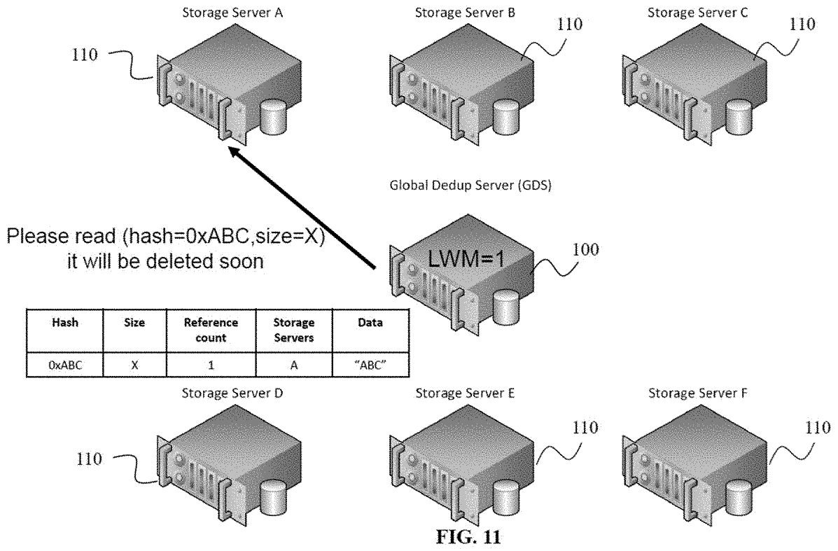

For instance, the second value, namely the LWM is 1, according to an embodiment of the disclosure as shown in FIG. 10 and FIG. 11. The reference counter associated with hash value “0×abc” is now 1, the data with hash value “0×abc” is considered to be not highly-duplicated. Thus, as shown in FIG. 11, the GDS according to an embodiment of the disclosure, sends an instruction to storage server A, which is still registered for the hash value “0×abc”. This is to instruct storage server A to copy the data from the GDS, since this data will be deleted soon.

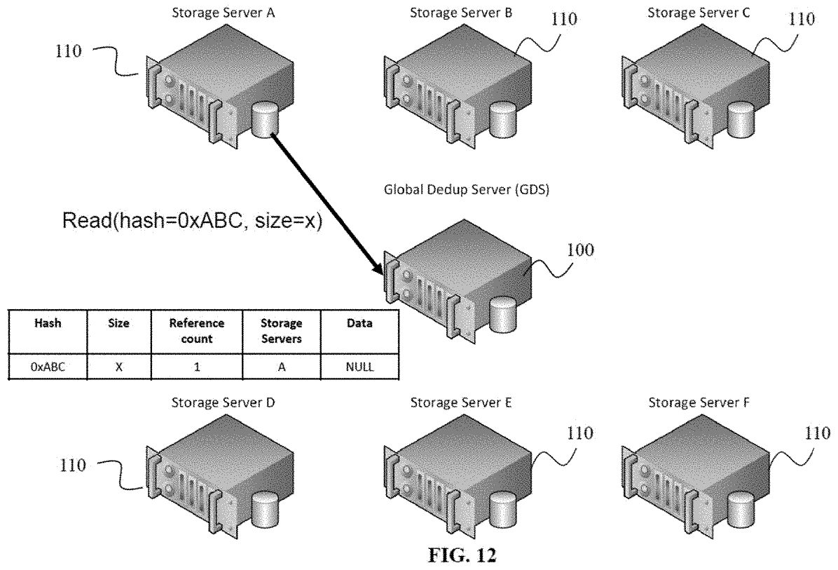

In the following, storage server A copies the data with hash value “0×abc” from the GDS, as shown in FIG. 12. After the data is stored by storage server A locally, the GDS can remove this data as shown in FIG. 12. Particularly, as shown in the table of FIG. 12, the part used to store the data “ABC” now displays “NULL”, which means that no data is stored. However, even the data is not stored in the GDS anymore, storage server A is still registered for the data with hash value “0×abc”, and the corresponding reference counter is still 1.

It should be understood that, while removal of some data is pending (waiting for all relevant storage servers to copy it), the GDS will continue to update the reference counter for this data when new request arrives. In case the corresponding reference counter exceeds again the HWM, the GDS will update all relevant storage servers. This may include storing the data and notifying all relevant storage servers.

In particular, the first value and second value according to embodiments of the disclosure, satisfy a condition that the first value is higher than the second value. That means, the HWM is higher that the LWM.

To avoid continually deleting and re-writing the same data, LWM should be set less than HWM. In a possible optimization, to avoid the case of continuous delete and re-write of the same chunk, an LWM per chunk might be stored. Then the LWM of this specific chunk may be decreased. In one example, a default configuration may be: HWM=7, and LWM=5.

For chunk A, ref_count=8 (data stored at the GDS), if the ref_count is decreased to 5, resulting in deletion of the chunk A. Then when ref_count of chunk A is increased to 7 again, the data will be re-written to the GDS. Thus, the GDS can then decrease LWM to 3 for chunk A only, to avoid the continuous deleting and re-writing.

Further, the HWM and the LWM can be defined based on percentages of the number of storage servers communicating with the GDS. It should be noted that, when free storage space of the GDS decreases below a certain threshold, the GDS is allowed to dynamically change its HWM and/or LWM. The global server 100 according to an embodiment of the disclosure, may be configured to adjust the first and/or second values dynamically, particularly based on free storage space left in the global server 100.

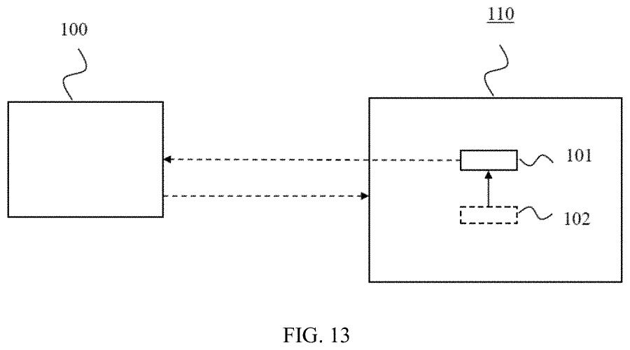

FIG. 13 shows a storage server 110 according to an embodiment of the disclosure. The storage server 110 may comprise processing circuitry (not shown) configured to perform, conduct or initiate the various operations of the storage server 110 described herein. The processing circuitry may comprise hardware and software. The hardware may comprise analog circuitry or digital circuitry, or both analog and digital circuitry. The digital circuitry may comprise components such as ASICs, FPGAs, DSPs, or multi-purpose processors. In one embodiment, the processing circuitry comprises one or more processors and a non-transitory memory connected to the one or more processors. The non-transitory memory may carry executable program code which, when executed by the one or more processors, causes the storage server 110 to perform, conduct or initiate the operations or methods described herein.

The storage server 110 is adapted for deduplicating at global servers. In particular, the storage server 110 shown in FIG. 13 is the same storage server 110 as shown in FIGS. 1-12. And the global server 100 shown in FIG. 13 is the same global server 100 as shown in FIGS. 1-12. The storage server 110, according to an embodiment of the disclosure, is configured to send, to the global server 100, a request 101 to store a data chunk 102. Further, the storage server 110 is configured to receive, from the global server 100, an information indicating that the global server 100 accepts the request 101 or rejects the request 101.

Since data stored by multiple deduplication servers or storage servers is often duplicated, to avoid a space loss, the storage server may request to store some data in a GDS.

Optionally, the request 101 sent to the global server 100 may comprise a hash value of the data chunk 102.

When a user writes data to the storage server 110, the storage server 110 may perform chunking and hashing of the data, to obtain a hash value of the data chunk. Therefore, the storage server 110, according to an embodiment of the disclosure, may be further configured to receive, from a user, a request to write the data chunk 102. Subsequently, the storage server 110 may be configured to store the hash value of the data chunk 102, based on the user's request.

Normally, a storage server will not send duplicate add or remove requests for the same data to the GDS. It is the responsibility of the storage server to identify duplicate requests for data from an end-user. This might be achieved by each storage server locally storing the hashes of data (including those data stored in the GDS), and reference counting for them (local deduplication). Thus, according to an embodiment of the disclosure, the storage server 110 may be configured to create or increase a local counter associated with the hash value.

In addition, for new data chunks received from the end-user, the storage server may also decide whether to send the hashes of the data chunks to the GDS. Therefore, according to an embodiment of the disclosure, the storage server 110 may be configured to determine, whether to send to the global server 100, the request 101 to store the data chunk 102, when the local counter is equal to or greater than 1.

It should be noted that, storage servers can decide which data to try to offload to the GDS. For instance, frequently accessed data might remain in the local storage server to allow for a low read latency. In addition, storage servers can also decide to cache some data locally (in addition to storing it in GDS), to improve read performance. Further, storage servers can also decide to not offload certain data to the GDS, e.g. some private data, or for security reasons.

After the storage server 110 requests to store a data chunk in the global server 100, when the information received from the global server 100 indicates that the global server 100 accepts the request 101, the storage server 110, according to an embodiment of the disclosure, may be configured to receive, from the global server 100, an instruction to send the data chunk 102 to the global server 100. In such case, it means that the data chunk 102 is highly-duplicated. In particular, this is the same step as shown in FIG. 6. And same as FIG. 7, the storage server 110 is further configured to send the data chunk 102 to the global server 100.

Alternatively, when the information received from the global server 100 indicates that the global server 100 rejects the request 101, the storage server 110 is configured to store the data chunk 102 locally. In such case, it means that the data chunk 102 is not highly-duplicated, then the storage server 110 needs to locally store the data chunk 102.

When a data chunk 102 is determined to be highly-duplicated by the global server 100, the global server 100 may inform the storage server 110 which has sent a request to store that data, that the data chunk 102 has been stored in the global server 100. Accordingly, the storage server 110 according to an embodiment of the disclosure, is configured to receive, from the global server 100, a notification that the data chunk 102 has been stored in the global server 100. The storage server 110 may be configured to remove the locally stored data chunk 102.

In case a user requests to read the data chunk 102 from the storage server 110, the storage server 110 may check when it is stored locally or it is in the GDS. When the data is in the GDS, the storage server 110 requests the data from the GDS. Thus, the storage server 110 according to embodiment of the disclosure, may be further configured to request the data chunk 102 from the global server 100, when a user requests to read the data chunk 102.

Notably, to improve read performance, the storage server 110 can also decide to cache some data locally, even the data has been stored in the GDS. Thus, the storage server 110 according to embodiment of the disclosure, may be further configured to additionally store the data chunk 102 locally.

In case a user requests to delete a data from the storage server 110, the storage server 110 according to embodiment of the disclosure, may be further configured to decrease a local counter associated with the hash value of the data chunk 102.

Optionally, when the local counter associated with the hash value of the data chunk 102 is equal to 0, that is, this is the last reference to the data chunk 102, the storage server 110 is configured to delete the data chunk 102 when it is locally stored. When the data chunk 102 is stored in the global server 100, the storage server 110 is configured to send, to the global server 100, a request 103 to remove that data chunk 102. In case the data chunk 102 is locally stored in the storage server 110 and also stored in the global server 100, the storage server 110 may delete the data chunk 102, and also request the global server 100 to remove the data chunk 102.

Optionally, the storage server 110 according to an embodiment of the disclosure, may be configured to receive, from the global server 100, an instruction to copy a data chunk 102 from the global server 100. This may be happened when the data chunk 102 is not highly-duplicated anymore. Accordingly, the storage server 110 may be configured to copy the data chunk 102 from the global server 100, and store the data chunk 102 locally.

Further, storage servers, according to embodiments of the disclosure, can start or stop communicating with the GDS without affecting other storage servers. In particular, the storage server 110 may be configured to determine to stop communicating with the global server 100. Then the storage server 110 may be configured to copy, from the global server 100, all data chunks 102 previously requested to be stored in the global server 100, and store the data chunks 102 locally. After that, the storage server 110 may be configured to stop communicating with the global server 100. Since all storage servers are independent with each other, one storage server leaving the topology will not affect other remaining storage servers.

This disclosure also provides a system comprising a global server 100 and multiple storage servers 110. For instance, the system according to an embodiment of the disclosure may be a system as shown in FIG. 2, or as shown in FIG. 3-12. In these topologies, the GDS is connected to all of its storage servers, but the storage servers do not need to be connected to each other (as opposed to distributed deduplication topology).

The GDS will be highly-available using known high availability (HA) techniques, such as mirroring, clustering or using Redundant Array of Inexpensive Disks (RAID), to prevent the GDS from being a single point of failure.

GDS may contain only highly cross-server deduplication data, particularly through the following means by allowing the GDS to reject requests to store data, by allowing the GDS to decide to vacate data and return ownership of it to the relevant storage servers, by allowing the GDS to dynamically update the LWN and/or HWM (using artificial intelligence (AI) or deterministic algorithms).

Further, storage servers are independent of each other, including the following advantages:

High latency between a storage server and the GDS will not affect other storage servers.

Storage servers can start or stop communicating with the GDS without affecting other storage servers.

Storage server communicate with the GDS in a many-to-one topology, while in distributed deduplication, the communication is many-to-many.

A structure of servers proposed by embodiments of the disclosure, can apply to situations such as not all storage servers have the same high availability level, and/or not all storage servers have the same latency. In this disclosure, any storage server can have different high availability level as the storage servers do not depend on each other. A high latency of one storage server affecting other storage servers, is effectively avoided, as it will exist in distributed deduplication architecture.

Furthermore, the latency for reading a data from a storage server is only affected by the latency between itself and the GDS. This is a benefit over distributed deduplication deployment, where the latency of read depends on the latency between the different storage servers belonging to one deduplication cluster.

The storage server can decide which data to offload to the GDS and which to continue storing locally, also allowing it to decrease latency. This solution is also scalable, since storage servers can be added and removed easily, also the GDS can be dynamically configured to support the amount of data allowed by its resources, by modifying the HWM and/or the LWM (e.g. by employing AI).

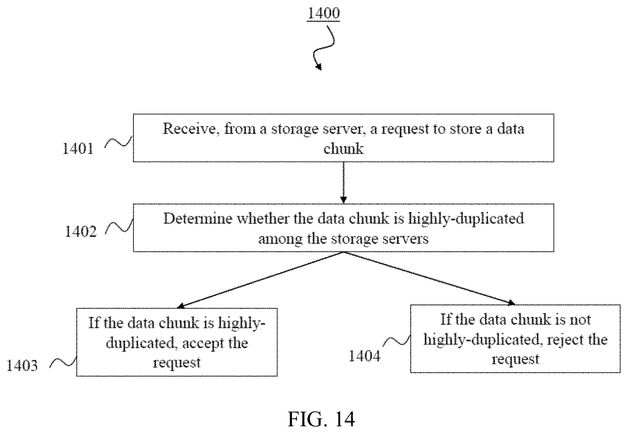

FIG. 14 shows a method 1400 performed by a global server 100 for deduplicating multiple storage servers 110 according to an embodiment of the present disclosure. In particular, the global server 100 is the global server 100 of FIG. 1. The method 1400 comprises:

Step 1401 of receiving, from a storage server 110, a request 101 to store a data chunk 102.

Step 1402 of determining whether the data chunk 102 is highly-duplicated among the storage servers 110.

Step 1403 of accepting the request 101, when the data chunk 102 is highly-duplicated.

Step 1404 of rejecting the request 101, when the data chunk 102 is not highly-duplicated. Particularly, the storage server 110 are the storage device 110 of FIG. 1.

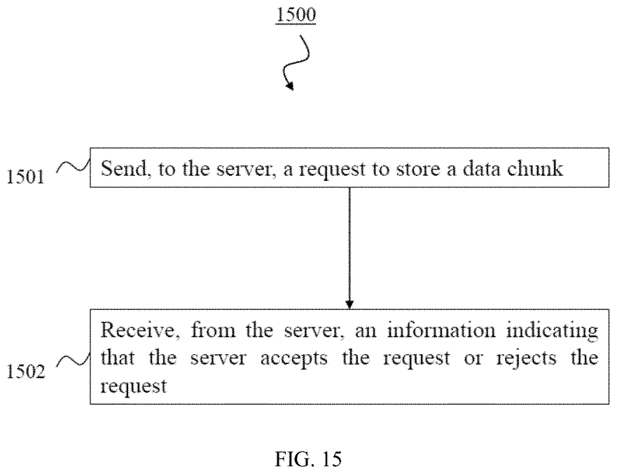

FIG. 15 shows a method 1500 performed by a storage server 110 for deduplicating at a global server 100, according to an embodiment of the present disclosure. In particular, the global server 100 is the global server 100 of FIG. 13, and the storage server 110 is the other storage server 110 of FIG. 13. The method 1500 comprises:

Step 1501 of sending, to the global server 100, a request 101 to store a data chunk 102.

Step 1502 of receiving, from the global server 100, an information indicating that the global server 100 accepts the request 101 or rejects the request 101.

The present disclosure has been described in conjunction with various embodiments as examples as well as implementations. However, other variations can be understood and effected by those persons skilled in the art and practicing the claimed disclosure, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

In addition, the benefits of the disclosure can be summarized as:

The storage servers are independent of each other.

It saves storage space via deduplication.

It allows highly-configurable control of resources and network traffic via HWM and LWM.

It allows easy deployment.

Simple scale-out (adding storage servers) and scale-down (removing storage servers).

The simple deployment reduces needed maintenance and the possibility to human errors.

Moreover, it is realized by the skilled person that embodiments of the global server 100 and the storage server 110 comprises the necessary communication capabilities in the form of e.g., functions, means, units, elements, etc., for performing the solution. Examples of other such means, units, elements and functions are processors, memory, buffers, control logic, encoders, decoders, mapping units, multipliers, decision units, selecting units, switches, inputs, outputs, antennas, amplifiers, receiver units, transmitter units, power supply units, power feeders, communication interfaces, etc. which are suitably arranged together for performing the solution.

Especially, the processor(s) of the global server 100 and the storage server 110 may comprise, e.g., one or more instances of a central processing unit (CPU), a processing unit, a processing circuit, a processor, an ASIC, a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the disclosure is not limited to the embodiments described above, but also relates to and incorporates all embodiments within the scope of the appended independent claims.

What is claimed is:

1. A global server for deduplicating a plurality of storage servers, wherein the global server comprises:
an interface; and
a processor coupled to the interface and configured to:
receive, using the interface from a first storage server in the storage servers, a first request to store a data chunk;
determine whether the data chunk is highly duplicated among the storage servers;
accept the first request when the data chunk is highly duplicated; and
reject the first request when the data chunk is not highly duplicated.

2. The global server of claim 1, wherein the processor is further configured to determine that the data chunk is highly duplicated among the storage servers when a water mark associated with a hash value of the data chunk is equal to or higher than a first value.

3. The global server of claim 2, wherein the first request comprises the hash value.

4. The global server of claim 3, wherein the processor is further configured to:
increase, upon receiving the first request, the water mark; and
register the first storage server for the hash value.

5. The global server of claim 4, wherein the processor is further configured to:
instruct the first storage server to send the data chunk to the global server when the water mark is equal to the first value; and
store the first data chunk.

6. The global server of claim 5, wherein the processor is further configured to notify the first storage server that the data chunk has been stored.

7. The global server of claim 2, wherein the processor is further configured to:
receive, using the interface from the first storage server, a second request to remove the data chunk;
decrease, upon receiving the second request, the water mark; and
unregister the first storage server for the hash value.

8. The global server of claim 2, wherein the processor is further configured to:
instruct each storage server registered for the hash value to copy the data chunk from the global server when the water mark is equal to or below a second value; and
remove the data chunk from the global server after all storage servers registered for the hash value store the data chunk locally.

9. The global server of the claim 8, wherein the first value is higher than the second value.

10. The global server of claim 8, wherein the processor is further configured to dynamically adjust, based on free storage space left in the global server, the first value or the second value.

11. A method implemented by a global server for deduplicating a plurality of storage servers, wherein the method comprises:
receiving, from a first storage server of the storage servers, a first request to store a data chunk; and
sending, to the first storage server, information indicating that the global server has accepted the first request or has rejected the first request.

12. The method of claim 11, further comprising determining that the data chunk is highly duplicated among the storage servers when a water mark associated with a hash value of the data chunk is equal to or higher than a first value.

13. The method of claim 12, wherein the first request comprises the hash value.

14. The method of claim 13, further comprising:
increasing, upon receiving the first request, the water mark; and
registering the first storage server for the hash value.

15. The method of claim 14, further comprising:
instructing the first storage server to send the data chunk to the global server when the water mark is equal to the first value; and
storing the data chunk.

16. The method of claim 15, further comprising notifying the first storage server that the data chunk has been stored.

17. The method of claim 12, further comprising:
receiving, from the first storage server, a second request to remove the data chunk;
decreasing, upon receiving the second request, the water mark; and
unregistering the first storage server for the hash value.

18. The method of claim 12, further comprising:
instructing each storage server registered for the hash value to copy the data chunk from the global server when the water mark is equal to or below a second value; and
removing the data chunk from the global server after all storage servers registered for the hash value store the data chunk locally.

19. The method of claim 18, wherein the first value is higher than the second value.

20. The method of claim 18, further comprising dynamically adjusting, based on free storage space left in the global server, the first value or the second value.
